(19) United States
(12) Patent Application Publication
(10) Pub. No.: US 2009/0123201 A1
(43) Pub. Date: May 14, 2009

(54) IMAGE FORMING APPARATUS

(76) Inventors: Masanao EHARA, Zama-shi (JP); Yoshiki YAMAGUCHI, Sagamihara-shi (JP); Naoki IWAYA, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/269,455

(22) Filed: Nov. 12, 2008

(30) Foreign Application Priority Data
Nov. 13, 2007 (JP) 2007-294285

(51) Int. Cl. G03G 15/20

(52) U.S. Cl. 399/328

(57) ABSTRACT

An image forming apparatus includes a transfer unit, a fuser unit, a relative positioning mechanism, and a fine adjustment mechanism. The transfer unit has a transfer nip to transfer an image from an imaging surface to a recording sheet passing therethrough. The fuser unit has a fixing nip to fix the transferred image on the recording sheet passing therethrough. The relative positioning mechanism is configured to position the transfer unit and the fuser unit relative to each other by contacting a contact portion with a flange. The contact portion is formed on one of the transfer unit and the fuser unit. The flange is formed on the other of the transfer unit and the fuser unit. The fine adjustment mechanism is configured to align the transfer nip and the fusing nip relative to each other.

### CROSS-REFERENCE TO RELATED APPLICATIONS

The present patent application claims priority pursuant to 35 U.S.C. §119 from Japanese Patent Application No. 2007-294285 filed on Nov. 13, 2007, the contents of which are hereby incorporated by reference herein in their entirety.

### BACKGROUND OF THE INVENTION

1. Field of the Invention

The present invention relates to an image forming apparatus, such as a photocopier, facsimile, printer, plotter, or multifunctional machine with image forming capabilities, and more particularly, to an electrophotographic image forming apparatus having a transfer unit and a fixing unit, where an image formed on a photoconductor or intermediate transfer member is transferred and fixed onto a recording sheet while successively passing through a transfer nip and a fixing nip arranged in conjunction with each other.

2. Discussion of the Background

In electrophotographic image formation, an electrostatic latent image is formed through charging and subsequent optical scanning of a rotating photoreceptive surface such as a drum or belt. Thereafter a developing device renders the latent image into visible form with toner. The photoconductive surface after development is advanced to a transfer device in which the toner image is transferred to a recording material, such as a paper sheet or plastic film, either directly or via an intermediate transfer member by passing through a transfer nip. Then, the recording sheet is forwarded to a fixing device in which the powder toner image is fused in place, for example, with heat and pressure applied to the recording sheet passing through a fusing nip.

In constructing such an electrophotographic imaging system, proper positioning of the transfer device and the fusing device is fundamental to good imaging and proper sheet transport. Misalignment of the transfer nip and the fixing nip results in displacement of images produced in the transfer and fixing processes, or curling and wrinkling of recording sheets traveling along the nip-to-nip path.

Conventional image forming apparatuses are designed with transfer and fuser units individually positioned and supported by a main frame of the apparatus. In order for the two devices to work properly in conjunction with each other, the conventional design requires dimensional control with close tolerances and precise alignment during manufacture, leading to high manufacturing costs and structural complexity. Moreover, even products that meet such high precision requirements can suffer lack of alignment and hence degraded imaging and sheet transport performance when operated under various conditions specified by individual users.

### SUMMARY OF THE INVENTION

Exemplary aspects of the present invention are put forward in view of the above-described circumstances, and provide a novel image forming apparatus that performs positioning and alignment of a transfer unit and a fuser unit relative to each other.

In one exemplary embodiment, the novel image forming apparatus includes a transfer unit, a fuser unit, a relative positioning mechanism, and a fine adjustment mechanism. The transfer unit has a transfer nip to transfer an image from an imaging surface to a recording sheet passing therethrough. The fuser unit has a fixing nip to fix the transferred image on the recording sheet passing therethrough. The relative positioning mechanism is configured to position the transfer unit and the fuser unit relative to each other by contacting a contact portion with a flange. The contact portion is formed on one of the transfer unit and the fuser unit. The flange is formed on the other of the transfer unit and the fuser unit. The fine adjustment mechanism is configured to align the transfer nip and the fusing nip relative to each other.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an embodiment of an image forming apparatus according to this patent specification;

FIGS. 2A through 2C illustrate in detail a basic configuration of a fuser unit included in the image forming apparatus of FIG. 1;

FIG. 3 schematically illustrates a relative positioning mechanism incorporated in the image forming apparatus of FIG. 1;

FIGS. 4A and 4B schematically depict spatial relation between a transfer nip, a fixing nip, and a recording sheet inside the image forming apparatus of FIG. 1;

FIG. 5 schematically illustrates one embodiment of a fine adjustment mechanism incorporated in the image forming apparatus of FIG. 1;

FIGS. 6A and 6B schematically illustrate another embodiment of the fine adjustment mechanism incorporated in the image forming apparatus of FIG. 1;

FIGS. 7A through 7D schematically illustrate one example of arrangement for positioning an adjustment plate in the fine adjustment mechanism of FIGS. 6A and 6B; and

FIGS. 8A and 8B schematically illustrate still another embodiment of the fine adjustment mechanism incorporated in the image forming apparatus of FIG. 1.

### DETAILED DESCRIPTION OF PREFERRED EMBODIMENTS

In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views, exemplary embodiments of the present patent application are described.

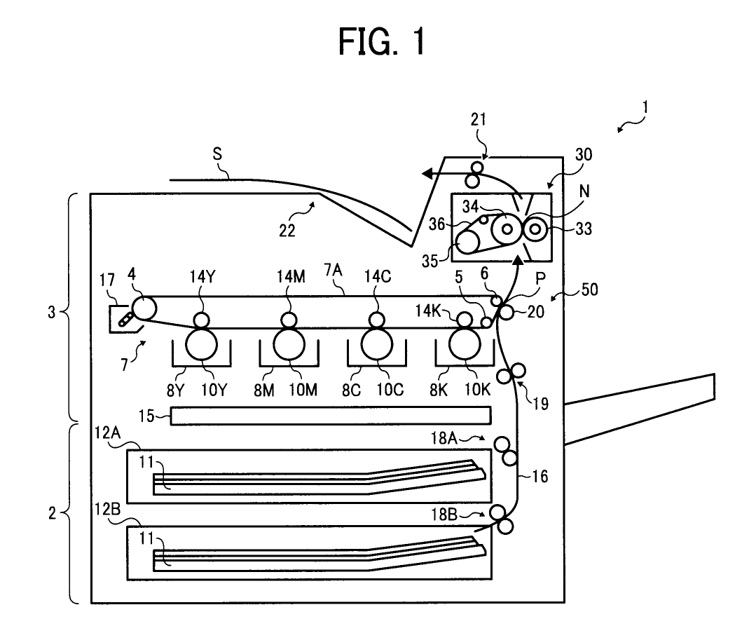

FIG. 1 schematically illustrates an embodiment of an image forming apparatus 1 according to this patent specification.

As shown in FIG. 1, the image forming apparatus 1 is configured as a color printer, with a lower sheet feeding section 2 and an upper printing section 3.

In the image forming apparatus 1, the sheet feeding section 2 includes stacked sheet trays 12A and 12B, each accommodating a stack of recording sheets 11. The printing section 3 includes multiple imaging units 8Y, 8M, 8C, and 8K, an intermediate transfer unit 7, a scanning unit 15, a fuser unit 30, and a transfer roller 20 forming part of a transfer unit 50.

Located in the middle of the printing section 3, the imaging units 8Y, 8M, 8C, and 8K each includes a photoconductive drum 10Y, 10M, 10C, and 10K, respectively, surrounded by a charging device, a developing device, a cleaning device, not shown, all of which are integrated into a single unit for detachable mounting on the image forming apparatus 1. Each imaging unit 8 uses toner of a particular color as indicated by the reference letters, “Y” for yellow, “M” for magenta, “C” for cyan, and “K” for black, communicating with a toner bottle, not shown, to supply the developing device with such color toner when required.

The scanning unit 15 is located below the imaging units 8, including laser sources, not shown, for optically scanning the photoconductive drums 10 from beneath.

The intermediate transfer unit 7 is located above the imaging units 8, including an intermediate transfer belt 7A trained around multiple rollers 4, 5, and 6 and primary transfer rollers 14Y, 14M, 14C, and 14K, as well as a belt cleaning device 17, all of which are integrated into a single unit for detachable mounting on the image forming apparatus 1. The intermediate transfer belt 7A is an endless flexible belt, passing through nips or gaps formed between each primary transfer roller 14 and its associated photoconductive drum 10, between the roller 4 and the cleaning device 17, and between the roller 6 and the transfer roller 20.

The transfer unit 50 is located adjacent to the intermediate transfer unit 7, forming a transfer nip P between the transfer roller 2 and its adjoining roller 6. The transfer unit 50 has its components housed in a movable structure as described later in more detail.

The fuser unit 30 is located above the transfer unit 50, forming a fixing nip N between a pressure roller 33 and a fixing roller 34 or a fixing belt 36. The fuser unit 30 has its components enclosed in a housing as described later in more detail.

In addition to the components forming the sheet feeding section 2 and the printing section 3, the image forming apparatus 1 includes upper and lower pairs of pickup rollers 18A and 18B, a pair of registration rollers 19, an output device 21, and other feed rollers, together defining a feed path 16 along which a recording sheet S travels from the sheet tray 12 upward to an output tray 22 while sequentially passing through the transfer nip P and the fixing nip N.

During operation, the printing section 3 forms a toner image in each imaging unit 14 as a motor, not shown, rotates the photoconductive drum 10 clockwise in the drawing to sequentially pass through electrophotographic processes.

In the imaging unit 14, first, the charging device uniformly charges an outer surface of the photoconductive drum 10 to a given polarity. The charged surface is then exposed to a modulated laser beam emitted by the scanning unit 15. The laser exposure forms an electrostatic latent image on each photoconductive surface according to image data of each separate color component, i.e., yellow, magenta, cyan, or black, contained in a multicolor image to be reproduced. The photoconductive surface then meets the developing device where the electrostatic latent image is developed into visible form with toner of the corresponding color.

In the intermediate transfer unit 7, a motor, not shown, drives one or more of the rollers 4, 5, and 6 so that the intermediate transfer belt 7A travels counterclockwise in the drawing. As a given area of the traveling belt 7A meets the yellow imaging unit 8Y, the magenta imaging unit 8M, the cyan imaging unit 8C, and the black imaging unit 8K in a timed sequence, the toner image on each photoconductive drum 10 transfers to the incoming area of the intermediate transfer belt 7A with the primary transfer roller 14 applying a bias voltage. As a result, yellow, magenta, cyan, and black toner images are superimposed one atop another to form a full-color toner image on the intermediate transfer belt 7A.

After the intermediate transfer process, the photoconductive drum 10 has its surface cleaned of residual toner by the cleaning device. The photoconductive surface is then discharged to an initial potential by the discharging device in preparation for the next imaging cycle.

In the sheet feeding section 2, the pickup rollers 18A and 18B rotate to feed a recording sheet S from the sheet stack 11 to the sheet path 16. The recording sheet S is then held by the registration rollers 19, and advances upward to the transfer nip P in registration with the movement of the intermediate transfer belt 7A. Thus, the full-color image formed on the belt surface is transferred to the recording sheet S passing through the transfer nip P, where a voltage of a polarity opposite to that of the charge on the toner image is applied to the transfer roller 20. Thereafter, the belt cleaning device 17 removes residual toner remaining on the intermediate transfer belt 7A, and the recoding sheet S is forwarded to the fuser unit 30.

In the fuser unit 30, the powder toner image on the recording sheet S is fused in place with heat and pressure as the recording sheet S passes through the fixing nip N. Subsequently, the recording sheet S bearing a finished image thereon reaches the end of the sheet path 16 for delivery to the output tray 22 by the output device 21.

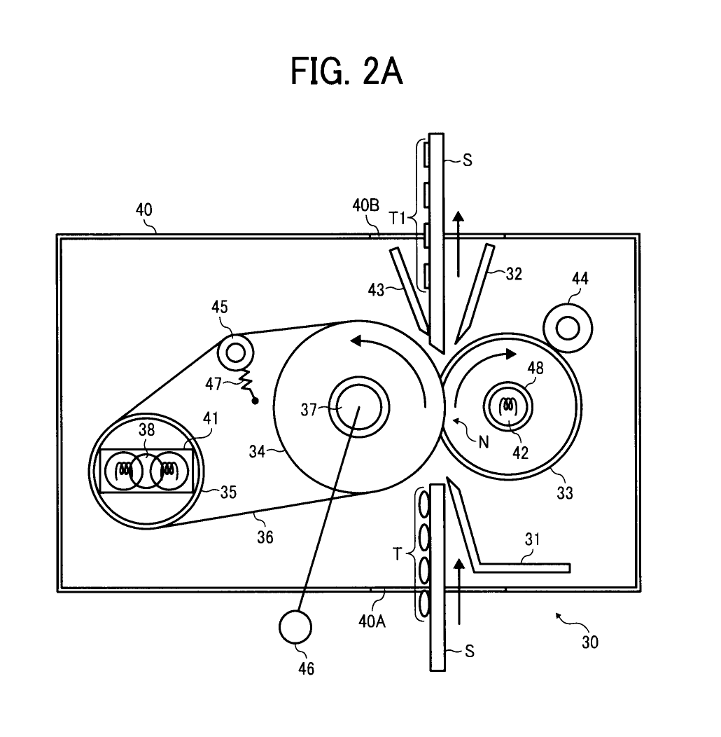

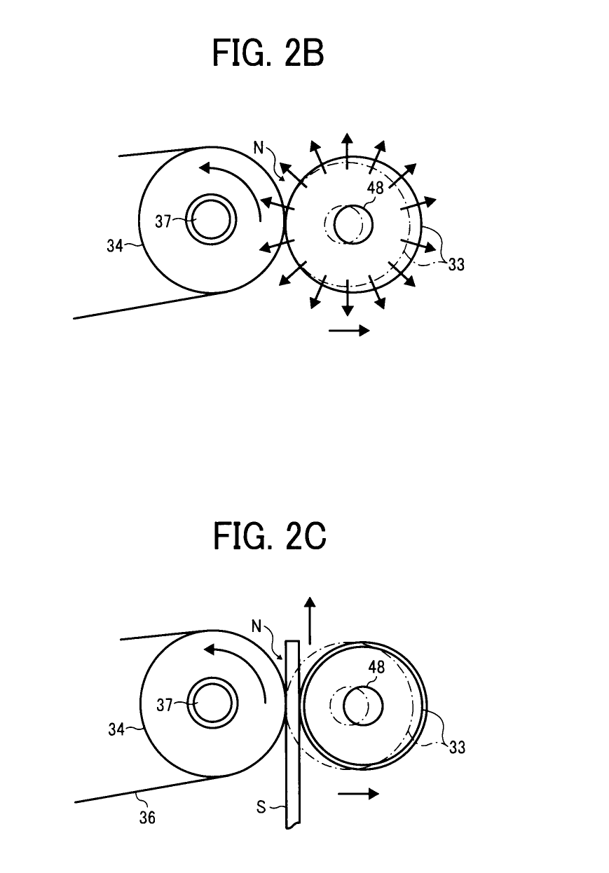

FIGS. 2A through 2C illustrate in detail a basic configuration of the fuser unit 30 included in the image forming apparatus 1.

As shown in FIG. 2A, the fuser unit 30 includes an inlet sheet guide 31, an outlet sheet guide 32, a heat roller 35, a sheet separator 43, a cleaning roller 44, and a tension roller 45 in addition to the pressure roller 33, the fixing roller 34, and the fixing belt 36, all enclosed in a fuser housing 40 with an inlet opening 40A and an outlet opening 40B communicating with the sheet path 16 for entry and exit of recording sheets S. The fuser housing 40 is removably mounted on the image forming apparatus 1, and surrounds the fuser components inaccessible to a user or maintenance personnel.

In the fuser unit 30, the fixing belt 36 is a looped endless belt made of heat-insulating material, streched around the fixing roller 34, the heat roller 35, and the tension roller 45.

The fixing roller 34 is made of elastic material such as rubber, with a shaft 37 rotatably supported by the fuser housing 40 to define a fixed axis of rotation. The roller shaft 37 is connected to a motor 46 that rotates the fixing roller 34 counterclockwise in the drawing, which in turn rotates the fixing belt 36 in accordance with the roller rotation.

The tension roller 45 is located in contact with an inner surface of the looped fixing belt 36. The tension roller 45 is biased against the belt inner surface with a spring 47 to maintain the fixing belt 36 under tension.

The heat roller 35 has a shaft 38 rotatably supported by the fuser housing 40 to define a fixed axis of rotation. The heat roller 35 includes a heater 41 to heat the fixing belt 36, formed of one or more heating elements (e.g., halogen elements) located either inside or outside the heat roller 35.

The pressure roller 33 is a hollow metal cylinder having a shaft 48 rotatably and adjustably supported by the fuser housing 40. The pressure roller 33 includes a heater 42 having one or more heating elements located inside the cylinder. The pressure roller 33 is biased against the fixing roller 34 by a spring or other suitable device, not shown, for rotation clockwise in the drawing.

The inlet sheet guide 31 is located between the inlet opening 40A and the fixing nip N, and the outlet sheet guide 32 is located between the fixing nip N and the outlet opening 40B, each mounted on the fuser housing 40 on the side of the pressure roller 33.

The sheet separator 43 is an elongated plate extending along the rotational axis of the fixing roller 34, with a functional edge, either toothed or non-toothed, spaced away from the surface of the fixing roller 34.

The cleaning roller 44 extends along the rotational axis of the pressure roller 33 with an outer surface thereof in contact with the surface of the pressure roller 33. The cleaning roller 44 is provided to remove residual toner and paper dust adhering to the pressure roller 33, but may be omitted depending on the configuration.

During operation, a recording sheet S bearing a powder toner image T thereon enters the fuser housing 40 via the inlet opening 40A, and advances to the fixing nip N along the inlet guide 31. As the sheet S passes through the fixing nip N, heat and pressure exerted on the recording sheet S renders the toner image T into a fixed permanent print T1. The recording sheet S is then separated from the fixing belt 36 by the sheet separator 43, and advances to the outlet opening 40B along the outlet guide 32.

In the present embodiment, the position of the pressure roller 33 or the roller shaft 48 is adjustable with respect to the fixing roller 34 or the roller shaft 37. For example, with reference to FIGS. 2B and 2C, the roller shaft 48 is slightly retracted from the fixing roller 34 or the roller shaft 37 in a substantially horizontal direction, when the diameter of the pressure roller 33 increases due to thermal expansion of metallic material, or when the thickness of recording sheet S entering the fixing nip N requires adjustment of the gap between the rollers 33 and 34.

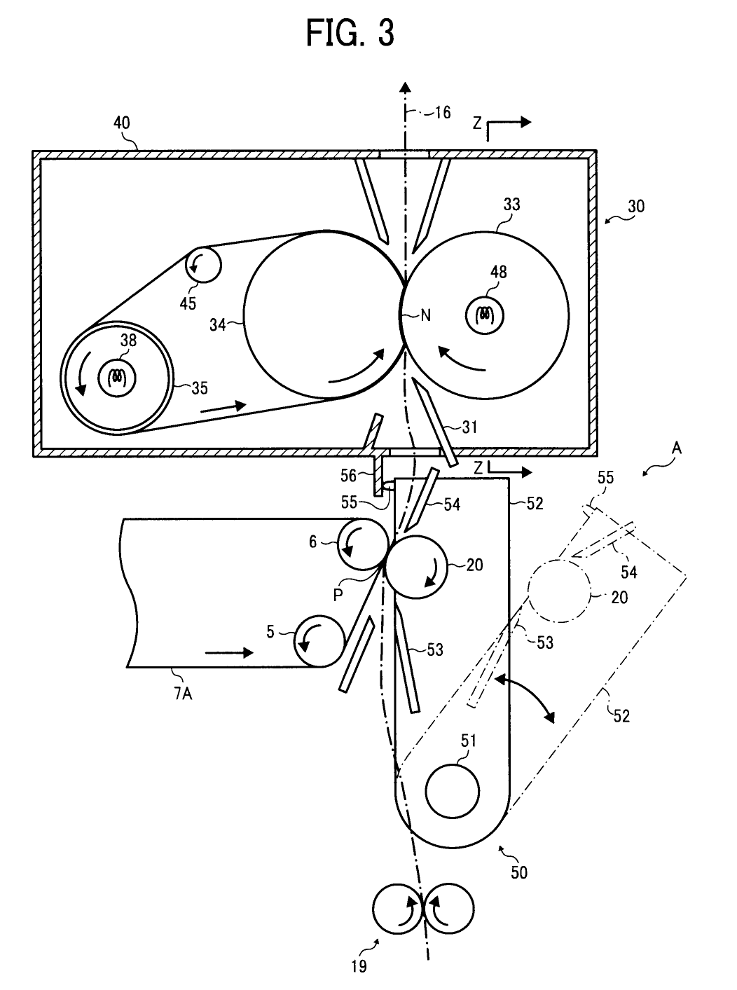

Having described basic configurations, referring to FIG. 3, a description is given of a mechanism A for positioning the fuser unit 30 and the transfer unit 50 relative to each other according to this patent specification.

As shown in FIG. 3, the relative positioning mechanism A provides the transfer unit 50 mounted on a movable transfer housing 52. The transfer housing 52 is supported rotatably about an axis 51 and has a contact portion 55 at an end distal from the rotation axis 51. The fuser unit 30 has a flange 56 at a lower side of the fuser housing 40 extending toward the transfer housing 52. The transfer unit 50 includes, in addition to the transfer roller 20 described above, a lower sheet guide 53 for guiding recording sheets to the transfer nip P and an upper sheet guide 54 for guiding recording sheets from the transfer nip P.

In such a configuration, the relative positioning mechanism A positions the transfer unit 50 relative to the fuser unit 30 by contacting the contact portion 55 with the flange 56. Once positioned, the transfer housing 52 is held substantially upright (solid lines in the drawing) by a suitable biasing member, not shown.

Thus, the relative positioning mechanism A positions the transfer unit 50 and the fuser unit 30 relative to each other without involving alignment of each respective unit with a main frame of the image forming apparatus 1. This effectively prevents misalignment between the transfer unit 50 and the fuser unit 30 due to an accumulation of dimensional errors present in different parts of the image forming apparatus 1. It can be appreciated that the size, shape, number, and/or location of the contact portion 55 and the flange 56 may be suitably designed to enhance accuracy in alignment between the transfer unit 50 and the fuser unit 30.

The guide 54 and the guide 31 may be configured as two separate plates mounted on the transfer housing 52 and the fuser housing 40, or as a single continuous plate mounted on either one of the transfer housing 52 and the fuser housing 40. Although the single-plate configuration provides lower manufacturing cost, the dual-plate configuration is effective in modifying the shape or position of the sheet path 16, with the relative positioning mechanism A facilitating adjustment of horizontal and vertical gaps between such separate guide plates.

In addition to the relative positioning described above, the image forming apparatus 1 performs fine adjustment of the relative positions of the transfer unit 50 and the fuser unit 30, defined by the relative positioning mechanism A. Such fine adjustment effectively corrects vertical and horizontal misalignments between the transfer nip P and the fixing nip N as described below.

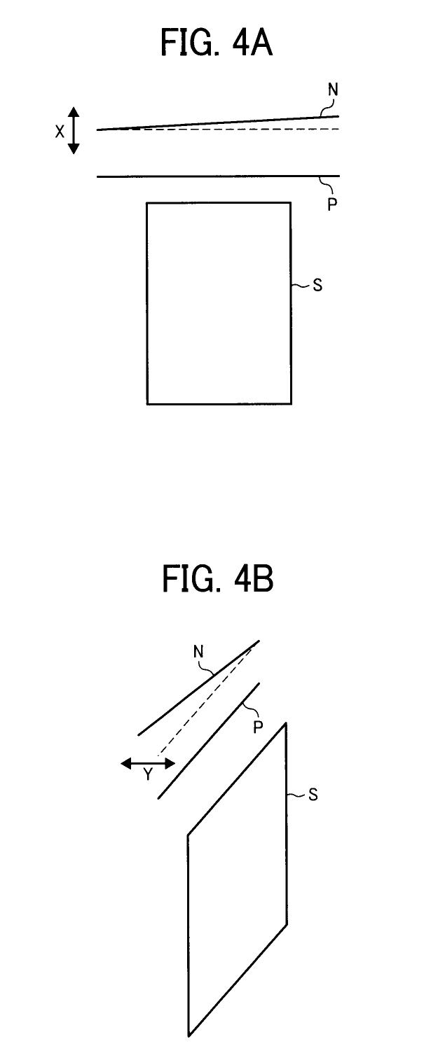

FIGS. 4A and 4B schematically depict spatial relation between the transfer nip P, the fixing nip N, and the recording sheet S in the sheet path 16 of the image forming apparatus 1. The vertical misalignment occurs when the fixing nip N deviates from parallel alignment with the transfer nip P, tilting in a direction indicated by arrow X (FIG. 4A). The horizontal misalignment occurs when the fixing nip N deviates from coplanar alignment with the transfer nip P, tilting in a direction indicated by arrow Y (FIG. 4B) perpendicular to the direction indicated by the arrow X. Obviously, such misalignments, if not corrected, would affect imaging quality of the image forming apparatus 1. It is generally known that the vertical displacement leads to curling or wrinkling of recording sheets traveling along the nip-to-nip path and deformation of images produced therethrough, and the horizontal misalignment results in scratches or blurs on printed images.

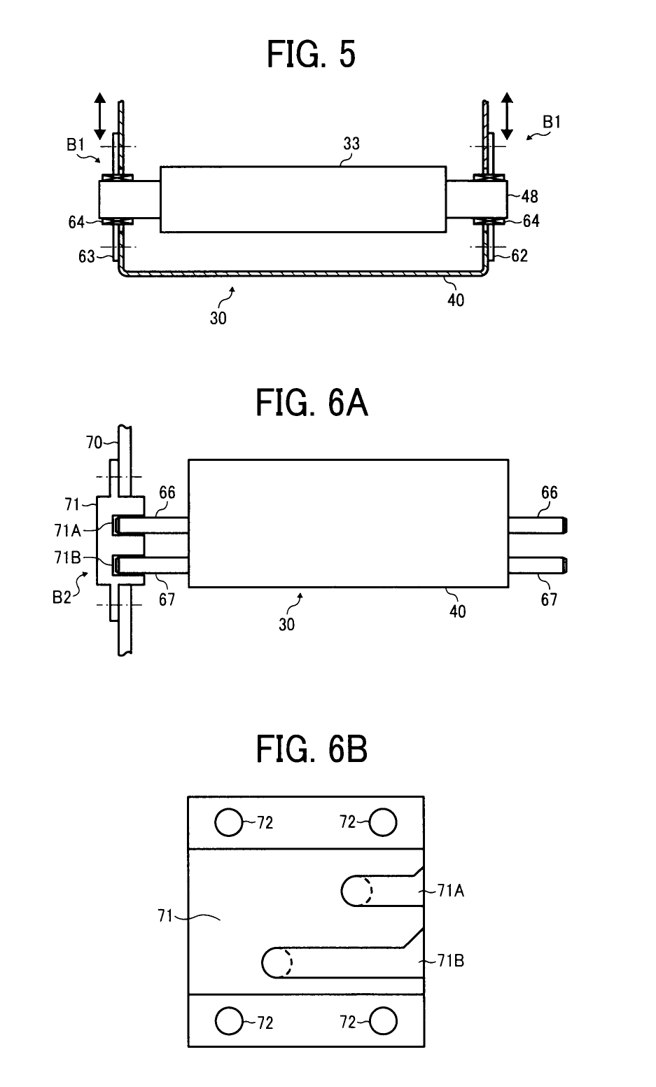

FIG. 5 schematically illustrates one embodiment of fine adjustment mechanism B1 according to this patent specification, showing the fuser unit 30 in cross-section taken along lines Z-Z of FIG. 4.

As shown in FIG. 5, the fine adjustment mechanism B1 includes the pressure roller 33 with opposite ends of the roller shaft 48 supported by bearings 64 coupled to adjustment plates 62 and 63. The adjustment plates 62 and 63 each has multiple screw holes selectively used to enable the adjustment plates 62 and 63 to be fastened onto the fuser housing 40. The position of the pressure roller 33 is modified by changing the screw holes used to attach the adjustment plates 62 and 63 to the fuser housing 40. The fine adjustment mechanism B1 is used in conjunction with the relative positioning mechanism A, although in FIG. 5 the flange 56 and other positioning components are omitted for simplicity.

The configuration described above allows repositioning of the pressure roller 33 relative to the adjoining fixing roller 34, and hence fine adjustment of the relative positions of the fixing nip N and the transfer nip P. This provides stable sheet transport along the nip-to-nip path while ensuring proper operation of the fixing belt 36 traveling through the fixing nip N.

FIGS. 6A and 6B schematically illustrate another embodiment of fine adjustment mechanism B2 according to this patent specification.

As shown in FIG. 6A, which is a side-elevational view taken from the right side of FIG. 4, the fine adjustment mechanism B2 includes the fuser unit 30 with two pairs of parallel pins 66 and 67 projecting from opposed first and second sides of the fuser housing 40. The pair of pins 66 and 67 on the first side are engaged in an adjustment plate 71 for mounting on a support or main frame 70 of the image forming apparatus 1, and secured in position with a suitable locking mechanism, not shown. In addition, the fine adjustment mechanism B2 is used in conjunction with the relative positioning mechanism A, although in FIG. 6A the flange 56 and other positioning components are omitted for simplicity.

With reference to FIG. 6B, the adjustment plate 71 has grooves 71A and 71B for engagement with the pins 66 and 67, and holes 72 to accommodate screws for screwing the adjustment plate 71 onto the apparatus main frame 70. The grooves 71A and 71B serve to guide the pins 66 and 67 when mounting the fuser housing 40 via the adjustment plate 71 screwed onto the main frame 70. The screw holes 72 have a diameter greater than that of screws to be used, allowing for variation in position of the adjustment plate 71 on the main frame 70 and of the fuser housing 40 connected to the main frame 70 via the adjustment plate 71.

The configuration described above allows repositioning of the fuser housing 40 in the image forming apparatus 1, and hence fine adjustment of the relative positions of the fixing nip N and the transfer nip P. In particular, the fine adjustment mechanism B2 interposed between the fuser unit 30 and the supporting frame 70 is simpler than the fine adjustment mechanism B1 which involves certain dismantling and assembling of the fuser unit 30 to provide adjustment in terms of the belt transport as well as the nip alignment.

While not depicted in the drawing, the fuser unit 30 has a train of drive gears on the second side of the fuser housing 40, which transmit driving force to components of the fuser unit 30. Preferably, the fine adjustment mechanism B2 is provided only on the first side of the housing 40 so as to prevent interference with engagement of the gear train and with operation of the fuser unit 30. However, it is also possible to provide the fine adjustment mechanism B2 with two adjustment plates on both the first and second sides of the fuser unit 30.

The operability of the fine adjustment mechanism B2 is increased by providing alignment marks on the main frame 70 and using suitable adjustment tools. In addition, the fine adjustment mechanism B2 may be automated when used in conjunction with a suitable drive.

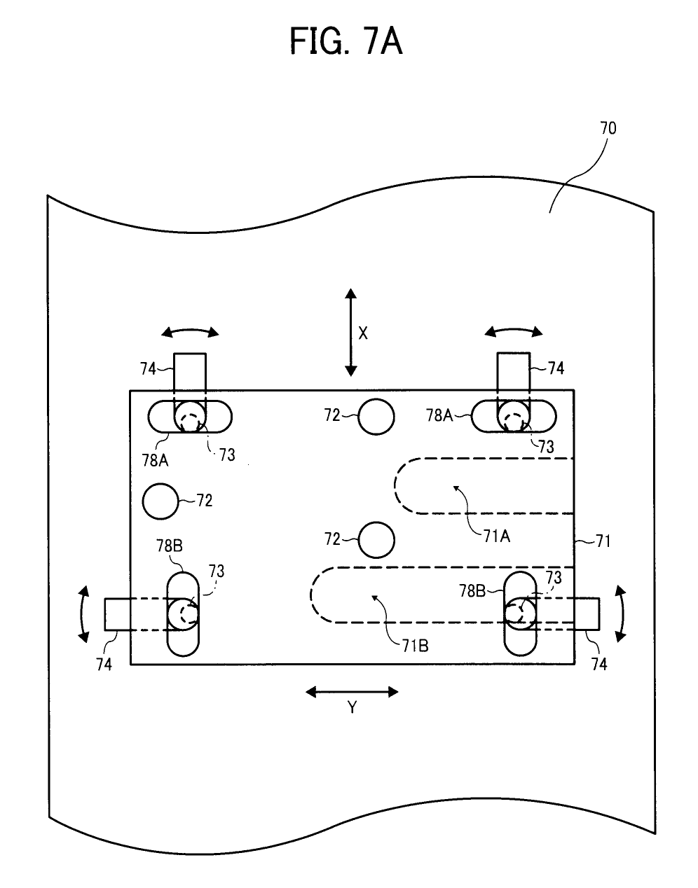

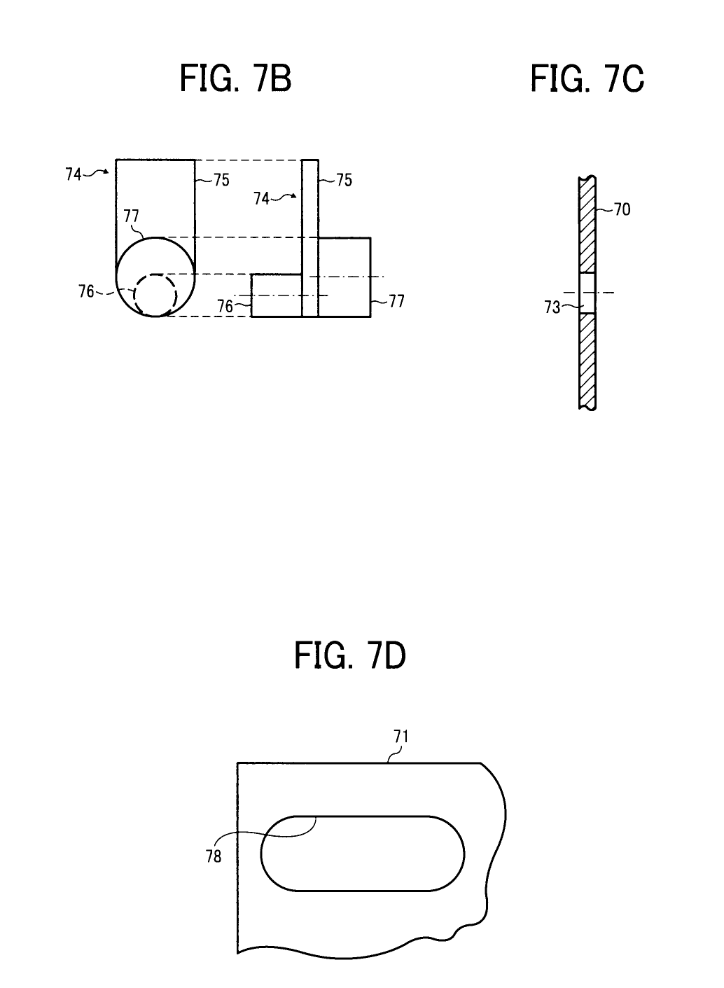

In a further embodiment, the fine adjustment mechanism B2 is arranged to facilitate positioning of the adjustment plate 71 on the supporting frame 70. FIGS. 7A through 7D schematically illustrate one example of such plate positioning arrangement.

As shown in FIG. 7A, the adjustment plate 71 is arranged to have a pair of horizontal guide slots 78A in the upper corners and a pair of vertical guide slots 78B in the lower corners. Each guide slot 78 holds an adjustment lever 74, which is also retained in a slot 73 formed in the apparatus main frame 70.

With reference to FIGS. 7B through 7C, the adjustment lever 74 has first and second cylindrical protrusions 76 and 77 formed on opposite sides of a flat handle 75 with their axes offset from each other (FIG. 7B). The first protrusion 76 is sized to fit in the retaining slot 73 formed in the main frame 70 (FIG. 7C), and the second protrusion 77 is sized to fit in the guide slot 78 formed in the adjustment plate 71 (FIG. 7D).

With reference to FIG. 7A, in use, the adjustment levers 74 in the guide slots 78A and 78B each initially has a free end pointing upward or sideward away from the adjustment plate 71. When each adjustment lever 74 is rotated about the first protrusion 76, the eccentric protrusion 77 displaces to move the adjustment plate 71. Specifically, rotating the adjustment levers 74 in the horizontal guide slots 78A moves the adjustment plate 71 in the vertical direction X, and rotating the adjustment levers 74 in the vertical guide slots 78B moves the adjustment plate 71 in the horizontal direction Y.

The plate positioning arrangement described above facilitates positioning of the adjustment plate 71 in the fine adjustment mechanism B2. In particular, the directional movement of the adjustment plate 71 enables the fine adjustment mechanism B2 to individually correct vertical and horizontal misalignments between the transfer nip P and the fixing nip N, preventing maladjustment and concomitant adverse effects due to mixing-up the vertical and horizontal directions X and Y in repositioning the adjustment plate 71.

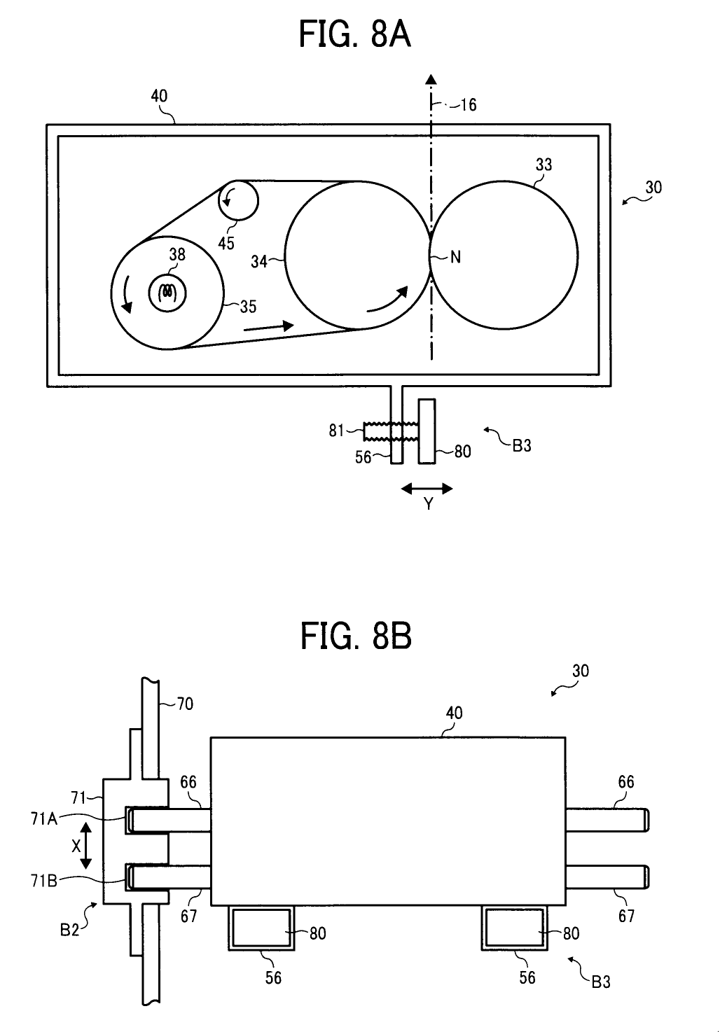

FIGS. 8A and 8B schematically illustrate still another embodiment of fine adjustment mechanism B3 according to this patent specification.

As shown in FIG. 8A, the fine adjustment mechanism B3 includes an extension 80 connected to the flange 56 via an adjustment screw 81. The position of the extension 80 may be varied in the horizontal direction Y by loosening or tightening the adjustment screw 81, so as to change the position of the transfer housing 52 defined by the relative positioning mechanism A. The same effect is obtained by providing the extension 80 on the contact portion 55 instead of the flange 80.

As shown in FIG. 8B, the fine adjustment mechanism B3 may be used in conjunction with the fine adjustment mechanism B2, which serves to adjust the position of the fuser housing 40 in the vertical direction X in a manner described above. The combined use of the two adjustment mechanisms B2 and B3 allows fine adjustment of the relative positions of the fixing nip N and the transfer nip P in both the vertical and horizontal directions X and Y, providing enhanced flexibility and higher precision in the alignment between the fuser unit 30 and the transfer unit 50.

Numerous additional modifications and variations are possible in light of the above teachings. For example, the relative positioning mechanism A is provided by rotating the transfer unit toward the fuser unit, it is also possible to form a movable fuser unit and a stationary transfer unit. It is therefore to be understood that, within the scope of the appended claims, the disclosure of this patent specification may be practiced otherwise than as specifically described herein.

What is claimed is:

1. An image forming apparatus, comprising:
a transfer unit having a transfer nip to transfer an image from an imaging surface to a recording sheet passing therethrough,
a fuser unit having a fixing nip to fix the transferred image on the recording sheet passing therethrough,
a relative positioning mechanism configured to position the transfer unit and the fuser unit relative to each other by contacting a contact portion with a flange,
the contact portion being formed on one of the transfer unit and the fuser unit,
the flange being formed on the other of the transfer unit and the fuser unit; and
a fine adjustment mechanism configured to align the transfer nip and the fusing nip relative to each other.

2. The image forming apparatus according to claim 1, wherein the fine adjustment mechanism connects the fuser unit to a frame supporting the fuser unit.

3. The image forming apparatus according to claim 1, wherein the fine adjustment mechanism and a driving mechanism are disposed on opposed first and second sides of the fuser unit.

4. The image forming apparatus according to claim 1, wherein the fine adjustment mechanism aligns the transfer nip and the fusing nip in vertical and horizontal directions independently.

5. The image forming apparatus according to claim 4, wherein the fine adjustment mechanism performs horizontal alignment by adjusting relative positions of the flange and the contact portion.

6. The image forming apparatus according to claim 4, wherein the fine adjustment mechanism performs vertical alignment by adjusting a position of the fuser unit on a frame supporting the fuser unit.
